(19) United States
(12) Patent Application Publication
(10) Pub. No.: US 2010/0121914 A1
(43) Pub. Date: May 13, 2010

(54) CONTENTS DELIVERY SYSTEM AND METHOD BASED ON CONTENT DELIVERY NETWORK PROVIDER AND REPLICATION SERVER THEREOF

(75) Inventors: Jae Sic JEON, Seoul (KR); Seon Ho SHIM, Seoul (KR); Kyong Hwan KIM, Seoul (KR)

Correspondence Address: LOWE HAUPTMAN HAM & BERNER, LLP, 1700 DIAGONAL ROAD, SUITE 300, ALEXANDRIA, VA, 22314, US

(73) Assignee: SK TELECOM CO., LTD., Seoul (KR)

(21) Appl. No.: 12/603,788

(22) Filed: Oct. 22, 2009

Related U.S. Application Data
(60) Provisional application No. 61/113,353, filed on Nov. 11, 2008.

(51) Int. Cl. G06F 15/16; G06F 17/30

(52) U.S. Cl. 709/203; 707/E17.032

(57) ABSTRACT

A contents delivery system and method through a CDN provider and a replication server thereof are provided. The replication server receives an embedded object of a page from a contents server of a contents provider and stores the embedded object. When the replication server receives a request for the page from a client, the replication server requests the contents server to provide the page, receives the page from the contents server and transmits the page to the client. When the replication server receives a request for the embedded object of the page from the client, the replication server transmits the embedded object stored therein to the client. Accordingly, the contents server of the contents provider can directly administrate pages and the contents provider can be aware of the number of requests for pages. Furthermore, the page is transmitted to the replication server from the contents server through a network of the CDN provider and then delivered to the client, and thus the client can receive the page rapidly as compared to the case that the client directly receives the page from the contents server.

### BACKGROUND OF THE INVENTION

1. Field of the Invention

The present invention relates to a contents delivery system and method, and a replication server thereof, and more particularly, to a contents delivery system and method through a contents delivery network (CDN) provider for transmitting a page and an embedded object of the page, provided by a contents server, to a client through a replication server which stores the embedded object and a replication server of the contents delivery system.

2. Description of the Related Art

A web server of a contents provider (CP) generally provides a large number of contents (for example, videos, music, files, etc.) to clients. A large load is generated when the web server provides the whole or some of the contents to a plurality of clients one to one because the plurality of clients exist in a plurality of Internet service providers (ISPs) while the web server is connected to a single ISP.

Accordingly, traffic between ISPs exponentially increases as the number of contents providers and clients increase, and thus transmission delay and/or transmission failure rate due to traffic congestion increase. Web server fail-over may occur in the worst case.

To solve this problem, a contents delivery network (CDN) is introduced. The CDN is a service which previously stores contents converging on a web server of a contents provider located at a great distance from clients, for example, contents with large capacity, such as pictures, banners, videos or audio, or contents frequently requested by clients, in host servers globally deployed at points of presence (PoP) of a plurality of ISPs and redirects the path of the host server closest to a client when the client requests the contents provider to provide contents such that the client accesses the host server through the redirected path to be provided with the contents. Here, the host server may be referred to as a cache server, a replication server or a ghost server.

In a prior art, a CDN provider stores only an embedded object of a page provided by a contents provider in a replication server and provides the embedded object to a client who receiving the page when the client requests the embedded object in order to rapidly provide the embedded object having capacity larger than the page to the client.

However, when the client receives the page from a remotely located contents server, round trip time (RTT) increases and thus a response speed increases. Accordingly, a method for solving this problem is required.

### SUMMARY OF THE INVENTION

The present invention provides a contents delivery system and method through a CDN provider in which a contents provider routes a request of a client for contents corresponding to a page to the CDN provider and a replication server receiving the request of the client receives the page from a contents server using a network of the CDN provider and provides the page received from the contents server and an embedded object of the page, which is previously stored in the replication server, to the client, and a replication server of the contents delivery system.

According to an aspect of the present invention, there is provided a contents delivery method through a content delivery network (CDN) provider, which includes a step in which a replication server of the CDN provider receives an embedded object of a page from a contents server storing the page and the embedded object and storing the embedded object; a step in which the replication server receives the page from the contents server and transmits the page to a client when a request for contents corresponding to the page is received from the client; and a step in which the replication server transmits the stored embedded object to the client when a request for the embedded object is received from the client.

The replication server may delete the page after transmitting the page to the client.

In the step in which the replication server transmits the page to the client, the client may request the contents server to provide the contents corresponding to the page, receive a hypertext transfer protocol (HTTP) 302 redirection message including a URL that indicates the position of the embedded object in the replication server from the contents server and request the replication server to provide the contents by using the URL.

In the step in which the replication server transmits the page to the client, the client may request the local name server to provide the IP address of the contents server, the local name server may receive information on the domain name corresponding to the replication server from the name server of the contents server through a canonical NAME (CNAME) method and transmit the IP address of the replication server to the client by using the domain name, and the client may request the replication server to provide the contents by using the IP address.

According to another aspect of the present invention, there is provided a replication server of a CDN provider, which includes a transmitting/receiving unit transmitting/receiving data; a database storing an embedded object of a page; and a controller storing the embedded object in the database when the embedded object is received from a contents server through the transmitting/receiving unit, receiving the page from the contents server through the transmitting/receiving unit and transmitting the page to a client through the transmitting/receiving unit when a request for contents corresponding to the page is received through the transmitting/receiving unit, and transmitting the embedded object stored in the database to the client through the transmitting/receiving unit when a request for the embedded object is received from the client that has received the page through the transmitting/receiving unit.

The controller may delete the page transmitted to the client. According to another aspect of the present invention, there is provided a contents delivery system through a CDN provider, which includes a contents server providing a page and an embedded object of the page, and a replication server receiving the embedded object from the contents server, storing the embedded object, receiving the page from the contents server and transmitting the page to a client when a request for contents corresponding to the page is received from the client, and transmitting the embedded object to the client when a request for the embedded object is received from the client that has received the page.

The replication server may delete the page transmitted to the client.

The client may request the contents server to provide the contents corresponding to the page, receive a an HTTP 302 redirection message including a URL that indicates the position of the embedded object in the replication server from the contents server and request the replication server to provide the contents by using the URL.

The client may request the local name server to provide the IP address of the contents server, the local name server may receive information on the domain name corresponding to the replication server from the name server of the contents server through a CNAME method and transmit the IP address of the replication server to the client by using the domain name, and the client may request the replication server to provide the contents by using the IP address.

According to the present invention, the contents server routes a request of the client for a page to the CDN provider and the client requests the replication server to provide the page. Then, the replication server receives the page provided by the contents server through the network of the CDN provider, which has a transmission speed higher than a plurality of ISP networks, and transmits the page to the client. Accordingly, a time required to transmit the page to the client can be reduced to shorter than the time required for the contents server to directly transmit the page to the remotely located client. Furthermore, the contents provider operating the contents server has the authority to control pages and can be aware of information such as the number of requests for each page, and thus the contents provider can use the information for receiving an order of advertisement. Moreover, a page can be rapidly transmitted to the client by using the network of the CDN provider without having a burden of transmitting the page updated frequently more than objects to the replication server and storing the page in the replication server whenever the page is updated.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a configuration of a contents delivery system through a CDN provider according to an embodiment of the present invention;

FIG. 2 is a block diagram of a replication server illustrated in FIG. 1;

FIG. 3 is a flowchart showing a contents delivery method according to an embodiment of the present invention; and

FIG. 4 is a flowchart showing a contents delivery method according to an embodiment of the present invention.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Throughout the drawings, like reference numerals refer to like elements.

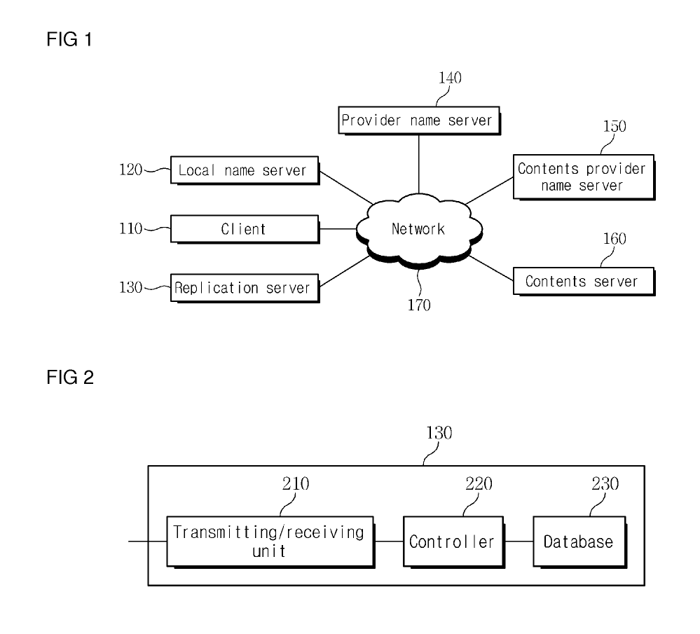

FIG. 1 illustrates a configuration of a contents delivery system through a CDN provider according to an embodiment of the present invention. Referring to FIG. 1, the contents delivery system includes a client 110, a local name server 120, a replication server 130, a provider name server 140, a contents provider name server 150, a contents server 160, and a network 170.

The client 110 corresponds to equipment such as a computer receiving information from the servers connected through the network 170. The client 110 includes a browser and a resolver. When a uniform resource locator (URL) that requests specific contents is input to the browser of the client 110, the resolver connected to the browser accesses the previously registered local name server 120 and resolves a domain name corresponding to the URL into the IP (Internet Protocol) address of the contents server 160 providing the contents.

In the current embodiment of the invention, the client 110 inquires of the local name server 120 about the IP address of a server which will transmit a page and an embedded object of the page. When the client 110 receives the IP address of the replication server 130 which will transmits the page and the embedded object from the local name server 120, the client 110 sequentially receives the page and the embedded object by using the IP address of the replication server 130.

The local name server 120 means a domain name server that transforms a domain name into an IP address and is a kind of name server that converts a symbolic name into a numeral address used by machines.

The local name server 120 transmits the IP address of the contents server 160 providing pages and objects to the client 110 by transmitting/receiving a message to/from the contents provider name server 150 corresponding to a name server of a contents provider or returns the IP address of the replication server 130 storing the embedded object to the client 110 by transmitting/receiving a message to/from the provider name server 140 corresponding to a name server of the CDN provider.

The replication server 130 is referred to as a cache server, for example, and corresponds to a server of the CDN provider, which stores replicas of embedded objects of pages stored in and administrated by the contents server 160. When the replication server 130 receives a request for a page provided by the contents server 160 from the client 110, the replication server 130 requests the contents server 160 to provide the page, receives the page from the contents server 160 and transmits the page to the client 110. When the replication server 130 receives a request for an embedded object of the page from the client 110, the replication server 130 transmits the embedded object previously stored therein to the client 110.

Here, the page received from the contents server 160 and transmitted to the client 110 is not stored in a separate storage and is deleted from a memory. This is because the replication server 130 requests the contents server 160 to provide a page requested by the client 110, receives the page and transmits the page to the client 110 whenever receiving the request for the page from the client 110.

The provider name server 140 has IP address information of the replication server 130. When the local name server 120 inquires of the provider name server 140 about the IP address of the replication server 130 which will transmit the page and the embedded object to the client 110, the provider name server 140 selects the replication server 130 suitable to respond to the request for the page and the embedded object and transmits the IP address of the replication server 130 to the client 110 via the local name server 120.

Here, the replication server 130 is selected based on at least one of data traffic information of the replication server 130, information on regional proximity of the client 110 and the replication server 130 and information on objects stored in the replication server 130.

The contents server 160 is a server of the contents provider providing pages and embedded objects of the pages. The contents server 160 transmits the embedded objects to the replication server 130 such that the replication server 130 stores the embedded objects. When the replication server 130 requests the contents server 160 to provide a page, the contents server 160 transmits the page to the replication server 130 through the network 170.

In the current embodiment of the invention, when the contents server 160 receives a request for a page from the client 110, the contents server 160 embeds the URL of the replication server storing an embedded object of the page in a hypertext transfer protocol (HTTP) 302 redirection message and transmits the HTTP 302 redirection message to the client 110. The HTTP 302 redirection message is one of response messages according to HTTP protocol for redirecting the request of the client 110 to a URL at a different position.

The contents provider name server 150 is a kind of name server to which the contents provider belongs. In the current embodiment of the invention, the contents provider name server 150 provides the IP address of the contents server 160 to the local name server 120. In another embodiment of the invention, the contents provider name server 150 may embed information on the domain name of the CDN provider in a canonical NAME (CNAME) record and transmit the CNAME record to the local name server 120 such that the page and the embedded object are transmitted to the client 110 via the replication server 130. The CNAME record means a DNS database record indicating a host name.

The network 170 corresponds to a data communication network for data transmission and information exchange among the client 110, the local name server 120, the replication server 130, the provider name server 140, the contents provider name server 150 and the contents server 160.

The configuration and operation of the contents provider name server 150 according to an embodiment of the present invention will now be explained in more detail with reference to FIG. 2.

FIG. 2 illustrates a configuration of the replication server 130 illustrated in FIG. 1 according to an embodiment of the present invention. Referring to FIGS. 1 and 2, the replication server 130 includes a transmitting/receiving unit 210, a controller 220 and a database 230.

The transmitting/receiving unit 210 has an interface for transmitting data and transmitting/receiving messages through the network 170.

The database 230 stores embedded objects received from the contents server 170.

When the controller 220 receives a request for contents from the client 110 through the transmitting/receiving unit 210, the controller 220 requests the contents server 160 to provide a page corresponding to the contents through the transmitting/receiving unit 210. When the controller 220 receives the page from the contents server 160 through the transmitting/receiving unit 210, the controller 220 transmits the received page to the client 110 through the transmitting/receiving unit 210.

When the controller 220 receives a request for an embedded object of the page from the client 110 through the transmitting/receiving unit, the controller 220 transmits the embedded object stored in the database 230 to the client 110 through the transmitting/receiving unit 210.

The page received from the contents server 160 and transmitted to the client 110 is not stored in the database 230 or a separate storage and is deleted in order to receives a page from the contents server 160 and transmit the page to the client 110 whenever the controller 220 receives a request for the page from the client 110.

In this manner, the contents server 160 can be aware of that the client 110 requests the page. Furthermore, the replication server 130 can receive a page from the contents server 160 through the network of the CDN provider and the client 110 can receive the page received by the replication server 130 through the network of the CDN provider. Accordingly, the client 110 can receive the page rapidly as compared to the case that the client 110 directly receives the page from the contents server 160.

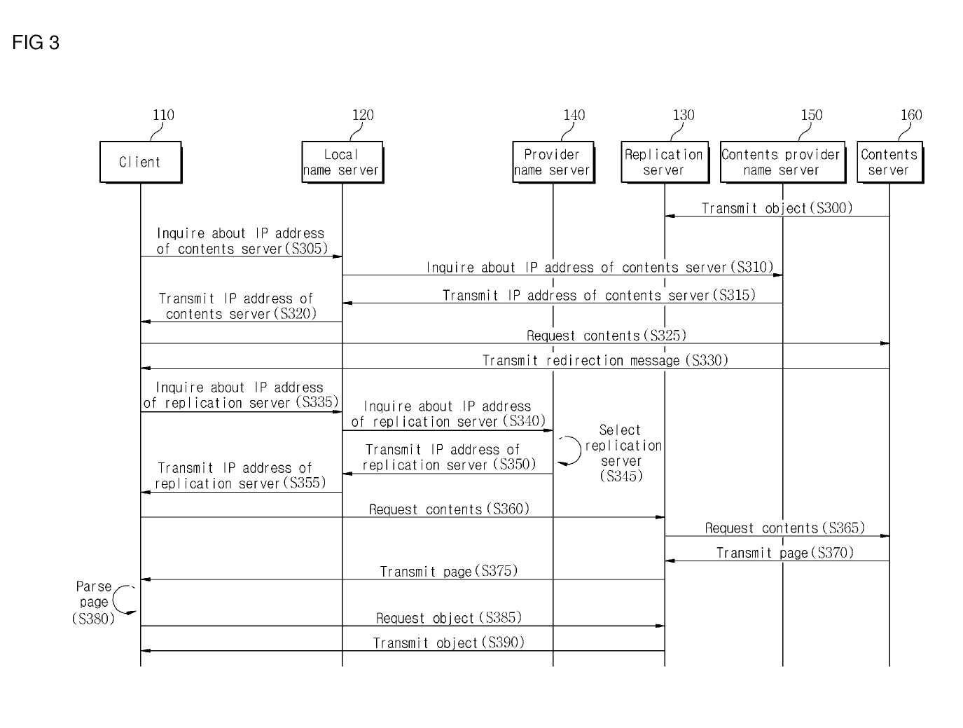

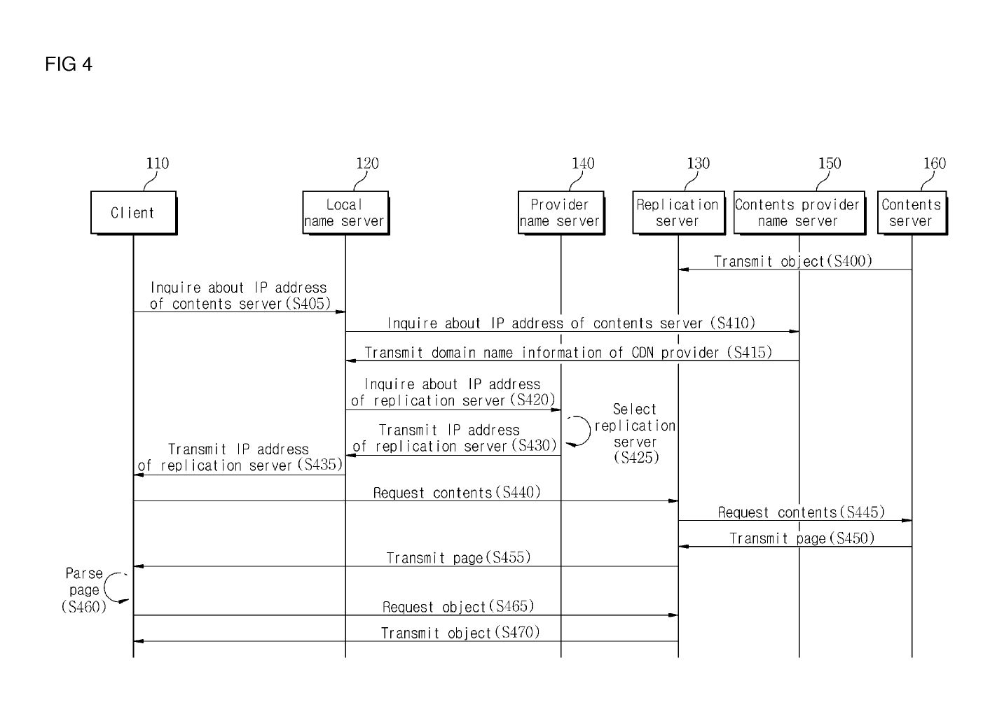

A contents delivery method through a CDN provider according to the present invention will now be explained with reference to FIGS. 3 and 4.

FIG. 3 is a flowchart showing a contents delivery method through a CDN provider according to an embodiment of the present invention. Referring to FIGS. 1 and 3, the replication server 130 receives an embedded object of a page of a contents provider from the contents server 160 and stores the embedded object in step S300. Here, the embedded object may be transmitted to the replication server 130 when the embedded object of the contents server 160 is updated at specific intervals at the request of the replication server 130.

When a URL for requesting the contents server 160 to provide contents is input to the browser of the client 110, the client 110 inquires of the local name server 120 about the IP address of the contents server 160 in step S305.

The local name server 120 receives the inquiry of the client 110 in step S305 and inquires of the contents provider name server 150 corresponding to the name server of the contents provider about the IP address of the contents server 160 in step S310.

The contents provider name server 150 receives the inquiry of the local name server in step S310 and transmits the IP address of the contents server 160 to the local name server 120 in step S315. The local name server 120 receives the IP address of the contents server 160 and transmits the IP address of the contents server 160 to the client 110 in step S320.

The client 110 receives the IP address of the contents server 160 in step S320 and requests the contents server 160 to provide the contents corresponding to a page by using the IP address of the contents server 160 in step S325. The contents server 160 receives the request of the client 110 in step S325, embeds a URL indicating a position at which an embedded object of the page is stored in the CDN provider in an HTTP 302 redirection message and transmits the HTTP 302 redirection message to the client 110 in step S330.

The client 110 receives the HTTP 302 redirection message including the URL indicating the position at which the embedded object is stored in the CDN provider in step S330 and inquires of the local name server 120 about the IP address of a replication server which will transmit the page and the embedded object by using the URL in step S335. The local name server 120 receives the inquiry of the client 110 and inquires of the provider name server 140 corresponding to the name server of the CDN provider about the IP address of the replication server which will transmit the page and the embedded object in step S340.

The provider name server 140 receives the inquiry from the local name server 120 in step S340 and selects the replication server 130 which will transmit the page and the embedded object to the client 110 in step S345. Here, the most suitable replication server 130 can be selected based on at least one of data traffic information of the replication server 130, information on regional proximity of the replication server 130 and the client 110 and information on objects stored in the replication server 130, for example.

The provider name server 140 transmits the IP address of the replication server 130 to the local name server 120 in step S350 and the local name server 120 transmits the IP address of the replication server 130 to the client 110 in step S355.

The client 110 receives the IP address of the replication server 130 in step S355 and requests the replication server 130 to provide the contents corresponding to the page by using the IP address of the replication server 130 in step S360. The replication server 130 receives the request of the client 110 in step S360 and requests the contents server 160 to provide the contents corresponding to the page in step S365.

The contents server 160 receives the request of the replication server 130 in step S365 and transmits the page corresponding to the contents to the replication server 130 in step S370. The replication server 130 receives the page in step S370 and transmits the page to the client 110 in step S375.

The client 110 receives the page from the replication server S375 and parses the received page in step S380. When the clients 110 detects an embedded page while parsing the page in step S380, the client 110 requests the replication server 130 to provide the embedded object by using the IP address of the replication server 130, received in step S355, in step S385 and receives the embedded object transmitted from the replication server 130 in step S390.

The page transmitted from the contents server 160 to the replication server 130 in step S370 and transmitted from the replication server 130 to the client 110 in step S375 is not stored in any storage and is deleted. This is for the purpose of requesting the contents server 160 to provide a page, receiving the page and transmitting the page to the client 110 whenever the client 110 requests a page.

FIG. 4 is a flowchart showing a contents delivery method according to another embodiment of the present invention. Referring to FIGS. 1 and 4, the replication server 130 receives embedded objects of pages of the contents provider from the contents server 160 and stores the embedded objects in step S400.

When a URL for requesting the contents server 160 to provide contents is input to the browser of the client 110, the client 110 inquires of the local name server 120 about the IP address of the contents server 160 storing a page corresponding to the contents and an embedded of the page in step S405.

The local name server 120 receives the inquiry from the client 110 in step S405 and inquires of the contents provider name server 150 corresponding to the name server of the contents provider about the IP address of the contents server 160 providing the page and the embedded object in step S410.

The contents provider name server 150 receives the inquiry from the local name server 120 in step S410 and transmits information on the domain name of a CDN provider which makes a contract with the contents provider operating the contents server 160 to the local name server 120 in step S415. Here, the domain name information of the CDN provider may be embedded in a CNAME resource record and delivered to the local name server 120.

The local name server 120 receives the domain name information of the CDN provider in step S415 and inquires of the provider name server 140 that is the name server of the CDN provider corresponding to the domain name about the IP address of a replication server which will transmit the page and the embedded object in step S420.

The provider name server 140 receives the inquiry from the local name server 120 in step S420 and selects the replication server 130 which will transmit the page and the embedded object to the client 110 in step S425. Here, the most suitable replication server 130 may be selected based on at least one of data traffic information of the replication server 130, information on regional proximity of the replication server 130 and the client 110 and information on objects stored in the replication server 130, for example.

The provider name server 140 transmits the IP address of the selected replication server 130 to the local name server 120 in step S430 and the local name server 120 sends the IP address of the replication server 130 to the client 110 in step S435.

The client 110 receives the IP address of the replication server 130 in step S435 and requests the replication server 130 to provide the contents corresponding to the page by using the IP address of the replication server 130 in step S440. The replication server 130 receives the request of the client 110 in step S440 and requests the contents server 160 to provide the contents corresponding to the page in step S445.

The contents server 160 receives the request of the replication server 130 in step S445 and transmits the page corresponding to the contents to the replication server 130 in step S450. The replication server 130 transmits the page received in step S450 to the client 110 in step S455.

The client 110 receives the page in step S455 and parses the received page in step S460. When the client 110 detects the embedded object while parsing the page in step S460, the client 110 requests the replication server 130 to provide the embedded object by using the IP address of the replication server, received in step S435, in step S465.

The replication server 130 receives the request of the client in step S465 and transmits the embedded object stored in step S400 to the client 110 in step S470.

The replication server 130 does not store the page and deletes the page after transmitting the page received from the contents server 160 in step S450 to the client 110 or after transmitting the embedded object to the client in step S470. This has been explained above so that detailed explanation is omitted.

According to the present invention, the client can receive a page and an embedded object of the page through the replication server and the contents provider can transmit the newest page to the replication server whenever the replication server requests the contents server to provide a page such that the page can be delivered to the client and be aware of the number of requests for pages. Furthermore, the client can rapidly receive a page and an embedded object of the page through the network of the CDN provider.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A contents delivery method through a content delivery network (CDN) provider, the contents delivery method comprising:
a step in which a replication server of the CDN provider receives an embedded object of a page from a contents server storing the page and the embedded object and storing the embedded object;
a step in which the replication server receives the page from the contents server and transmits the page to a client when a request for contents corresponding to the page is received from the client; and
a step in which the replication server transmits the stored embedded object to the client when a request for the embedded object is received from the client.

2. The contents delivery method of claim 1, wherein the replication server deletes the page after transmitting the page to the client.

3. The contents delivery method of claim 1, wherein, in the step in which the replication server transmits the page to the client, the client requests the contents server to provide the contents corresponding to the page, receives a hypertext transfer protocol (HTTP) 302 redirection message including a URL that indicates the position of the embedded object in the replication server from the contents server and requests the replication server to provide the contents by using the URL.

4. The contents delivery method of claim 1, wherein, in the step in which the replication server transmits the page to the client, the client requests the local name server to provide the IP address of the contents server, the local name server receives information on the domain name corresponding to the replication server from the name server of the contents server through a canonical NAME (CNAME) method and transmits the IP address of the replication server to the client by using the domain name, and the client requests the replication server to provide the contents by using the IP address.

5. A replication server of a CDN provider, comprising:
a transmitting/receiving unit transmitting/receiving data;
a database storing an embedded object of a page; and
a controller storing the embedded object in the database when the embedded object is received from a contents server through the transmitting/receiving unit, receiving the page from the contents server through the transmitting/receiving unit and transmitting the page to a client through the transmitting/receiving unit when a request for contents corresponding to the page is received through the transmitting/receiving unit, and transmitting the embedded object stored in the database to the client through the transmitting/receiving unit when a request for the embedded object is received from the client that has received the page through the transmitting/receiving unit.

6. The replication server of claim 5, wherein the controller deletes the page transmitted to the client.

7. A contents delivery system through a CDN provider, comprising:
a contents server providing a page and an embedded object of the page; and
a replication server receiving the embedded object from the contents server, storing the embedded object, receiving the page from the contents server and transmitting the page to a client when a request for contents corresponding to the page is received from the client, and transmitting the embedded object to the client when a request for the embedded object is received from the client that has received the page.

8. The contents delivery system of claim 7, wherein the replication server deletes the page transmitted to the client.

9. The contents delivery system of claim 7, wherein the client requests the contents server to provide the contents corresponding to the page, receives a an HTTP 302 redirection message including a URL that indicates the position of the embedded object in the replication server from the contents server and requests the replication server to provide the contents by using the URL.

10. The contents delivery system of claim 7, wherein the client requests the local name server to provide the IP address of the contents server, the local name server receives information on the domain name corresponding to the replication server from the name server of the contents server through a CNAME method and transmits the IP address of the replication server to the client by using the domain name, and the client requests the replication server to provide the contents by using the IP address.
